(19) United States
(12) Patent Application Publication
(10) Pub. No.: US 2002/0130185 A1
(43) Pub. Date: Sep. 19, 2002

(54) System for creating and reading digital business cards, forms, and stationery

(76) Inventors: Laurence Edward LaForge, Reno, NV (US); Derek D. Carlson, Los Angeles, CA (US); Kirk Fredrick Korver, Reno, NV (US)

Correspondence Address: NATH & ASSOCIATES, 1030 15th STREET, 6TH FLOOR, WASHINGTON, DC, 20005, US

(21) Appl. No.: 10/055,011

(22) Filed: Jan. 25, 2002

Related U.S. Application Data
(60) Provisional application No. 60/263,718, filed on Jan. 25, 2001.

(51) Int. Cl. G06K 19/00

(52) U.S. Cl. 235/487

(57) ABSTRACT

The invention creates and reads digital business cards, forms, and stationery. In its capacity as creator, the invention digitizes contact information into a representation suitable for printing, or otherwise transferring, to business cards. More generally, the invention converts files created by any computer application into a digital representation especially suitable for printing, or otherwise transferring, to paper, cardboard, or alternate media. In its capacity as reader, the invention transfers such digitized representations from business cards, forms, or stationery to computer applications. Beneficial applications include the automated scanning of digital business cards into electronic address books and Personal Information Managers, as well as the automated transfer of application-specific forms from paper to online systems for filing and data processing.

### BACKGROUND OF THE INVENTION

By standardizing the transfer of information between application software and paper, the invention serves as an enabling bridge among people, paper, and computers. From Thomas Alva Edison to the present day, pundits have prematurely predicted the paperless office. Assessing why this transformation has not, in fact, transpired, [Sellen and Harper 2001] conclude that technologies—from the tin-foil speaking machine '521 to the transistorized touch screen—have been insufficient to supplant paper, and furthermore will not supplant paper in the foreseeable future. This trend pertains in particular to business cards printed onto paper stock [Alphonso 2000].

As underscored by [Grant 1998], the business card serves both to make an impression on people—implicitly, explicitly, perhaps emotionally—and to convey contact information, such as the bearer's name, title, address, and phone number. In practice, these two functions may not always be distinguishable: the expression of what one says generally imparts connotations. We are therefore impelled to accurately and automatically convey digitized contact information between business cards and the computers on which people rely.

The absence of such a mechanism for conveying contact information is, we submit, largely due to the disruptive, discontiguous nature of combining magnetic stripes, holograms, smart chips, shaped compact disks, or other computer-readable materials, with the paper stock on which business cards are traditionally printed. In 1997, for example, our research reveals that, in the United States alone, more than 32 million sets of business cards, averaging 500 cards per set, were commercially printed onto paper stock, with an aggregate retail value of approximately $1.3B. The average price per business card, therefore, is approximately 10 cents. By contrast, business cards made of computer-readable materials, other than paper, are fraught with economic shortcomings: the unit cost exceeds $1, and it is expensive for printing firms to change the way they make business cards. Composite business cards, such as those suggested by Tanaka '219, suffer from the cost of discontiguous technology, for similar reasons.

Okamoto '033 introduced a bar-coded business card which, although falling short of the present invention's scope, objective, and function, relates to the present invention as a building block—in a fashion analogous to the way in which the transistor is a building block of innovative circuits.

The benefits of digital business cards would be leveraged if used in conjunction with computer programs known as Personal Information Managers, or PIM's. PIM's have come into widespread use over the past decade. They typically combine electronic address books with functions that automate office tasks. For example, most PIM's organize contact information, and, via a graphical user interface (GUI), automate office tasks such as the printing of mailing labels, the recalling and dialing of stored phone numbers, and the recording, recalling, and issuing of reminders for appointments. As a variant on PIM's, Customer Relation Managers, or CRM's, afford sales representatives with additional features; e.g., tracking the status of client orders. In a contemporary setting, Microsoft® Outlook™ is an example of a PIM, while Interact ACT!™ exemplifies CRM's. Personal digital assistants (PDA's), such as those manufactured by Palm™, incorporate a PIM as the so-called killer application that enables the PDA's usefulness.

A number of vendors have employed optical character recognition (OCR) to automate the scanning of contact information from traditional business cards into PIM's. Corex CardScan™ is an example of a product that employs OCR to achieve this objective. However, OCR suffers not only from character substitution errors, but also from transferring text strings—ostensibly correctly read—into the wrong fields of the PIM. The combination of these two error types results in less than 20% of business cards being scanned correctly, as measured by a super-Guassian random sample. Furthermore, the time and effort saved by OCR-based scanning falls short of what one might expect. This is illustrated by measurements on a 35-word-per minute typist. On average, it takes one minute, forty-six seconds to correctly key information from a business card to a PIM. Using the same test set, it takes, on average, more than one-minute, forty-one seconds to scan and correct a business card, when employing OCR-based software designed expressly for this purpose. The user therefore saves only 5%—approximately five seconds total—when compared to baseline measurements for the same contact information keyed in directly. As to the effort for correcting contact information scanned with such OCR-based software, the user expends in excess of 15 keystrokes and mouse clicks per card.

Compare the preceding statistics with the present invention, reduced to practice as a prototypical embodiment that scans business cards digitized with bar codes. Herein we find that scanning contact information takes less than one-tenth the time of OCR-based software, and yields accuracies in excess of 99%. Furthermore, it is possible to include more information in a bar code than can be presented in a form readable by the naked eye.

To recap: business cards featuring a digital encoding would offer compelling benefits, especially when expressed in a form that is compatible with printing materials and processes based on ink and paper. These advantages pertain in particular to business cards imprinted with a bar code that faithfully renders PIM-compatible contact information. To achieve these benefits on a widespread basis, moreover, requires a system for a) automating the capture of contact information; b) digitizing the information—ostensibly as an image of a bar code—in a fashion that facilitates printing via commercial or desktop presses; c) automating the input of the digitized representation—ostensibly by scanning a bar code; d) converting the digitized representation into a format compatible with a PIM; and e) transferring the converted format to the PIM. In addition, a computer program which automates this system would benefit from f) a standardized representation of contact information, manifested both as an online computer file and an image of an encoding of the file. The standard file format would facilitate the online editing of contact information, and could furthermore serve as an intermediate format that enables transfer to or, in the case of automated capture, from a PIM.

It is therefore an objective of the present invention to enable digital encodings of contact information on business cards, with attendant benefits. This applies particularly to bar codes printed as standard ink or toner on business cards of standard paper stock.

It is the further objective of the present invention to manifest (a) through (e) of the system set forth above, or to manifest as a system which implements and automates steps (a) through (e), or as any combination of subsets of (a) through (e). It is the further objective of the invention to standardize a representation of contact information, (f) as stated above.

It is the further objective of the invention to operate across a broad spectrum of processes and systems for manufacturing business cards. Running a personal computer, for example, the do-it-yourself user can make business cards on Avery 5371 perforated sheets, or similar sheets, by employing a desktop printer and any of several existing software packages, such as CorelDraw™. g) It is a particular objective of the invention to enable the creation of digital encodings on such do-it-yourself business cards, produced using substantially identical computers, desktop printers, and materials. In other cases, for example, users order commercially printed business cards through the website of a printing firm, such as BCT (formerly Business Cards Tomorrow). h) It is a particular objective of the invention to interact with such ordering systems, and to enable the creation of digital encodings on business cards so produced.

It is the further objective of the invention to operate across a broad spectrum of methods and systems for inputting digital business cards. In the particular case of bar-coded business cards, for example, it is an objective of the invention to scan using i) general purpose flatbed or contact scanners, such as the inexpensive TWAIN-compatible models offered by Microtek; j) business card scanners, such as those which accompany the Corex CardScan™ software mentioned previously; k) special purpose bar code scanners, such as the LS4804 manufactured by Symbol Technologies. These examples are illustrative and non-exhaustive.

With respect to (a) through (f), it is the emphatic objective of the invention to provide a multi-platform mechanism of interchange among digital business cards, PIM's, and programs associated with PIM's.

It is also a particular objective of the invention to provide a convenient computer file format (f), as a standard which can, for example, be transmitted from one person to another by email, or manipulated by a spectrum of programs, perhaps through an application interface (API) to a programmatic implementation of the invention. Such a standard includes, but is not limited to, programmatic compatibility with an Internet Mail Consortium vCard [vCard 1996].

The combination of objectives (g) and (h) is particularly innovative, since a system featuring this combination accommodates both do-it-yourself business cards and business cards printed on a professional press. The latter includes not only for-hire printers, but also in-house reprographics services present in many companies and organizations.

The preceding objectives may be further combined in an innovative manner. For example, a version of the invention that creates digital business cards may garner profits for sellers of software and stationery, while a sample version, capable of reading but not creating, may be made available at no charge.

Having unfolded both the usefulness and novelty of digital business cards, and of a method and/or system to inexpensively create and read digital business cards across a variety of computers, input devices, and processes for manufacture, let us consider a variant of the invention for creating and reading digital forms and stationery.

With the prevalence of word processing and accounting software, a large portion—perhaps most—of the forms, business letters, and professional documents committed to paper originate through a computer. With paper as the required or preferred medium in a significant fraction of transactions, it is advantageous to simultaneously store a digitized paper copy on or with the form, letter, or document.

For example, many firms are turning to document management systems (DMS) as replacements for filing cabinets. With the present state-of-the-art, however, paper documents must be scanned with inferior results [Sellen and Harper 2001]. Scanning such documents as images consumes a great deal of time and secondary storage, and affords no intrinsic ability for online functions such as full text search. Scanning such documents using OCR incurs errors as in the case of business cards, with attendant loss in accuracy or expense of correction by hand. It is therefore desirable to provide a paper-based digital channel of communication which augments, or in some cases replaces, email, Internet file transfer, diskettes, or compact disks. The invention provides this novel channel, without inconveniencing the originator to compose a diskette or compact disk.

At present, for example, the United States Patent Office is geared toward paper applications for utility patents. Even the web-based submission mechanism is, in fact, a surrogate system for paper delivery. Applications filed over the Internet are printed by Patent Office representatives, then forwarded as in the case of paper submissions. Were the invention employed, paper submissions would be simultaneously human-readable and digitally encoded. Imagine, say, a ten-page patent application, accompanied by two pages of bar codes, suitably labeled with human-readable captions to identify the document to which they belong. Scanning in the bar-coded pages captures the submission in its online form, say, Microsoft® Word or Adobe® Acrobat®. As with the latter, widespread adoption of the invention would give patent office professionals a better chance of being able to use software to more efficiently process submissions. Similar benefits would apply to invoices, mortgage payments, and the like.

As a further benefit, this innovative variant expedites digitized, encrypted paper documents, with contents concealed from human eyes.

A further benefit of this variant is that it largely obviates the necessity for custom programming of tracking bar codes on forms. The skill required to use the invention—to create or read a digital form, letter, or other document would be no greater than, to cite an example, that for creating or reading a PDF document via Adobe® Acrobat®. In a preferred embodiment, the invention would present a GUI listing of the files to be created on paper, or read from paper, in a fashion familiar to users of, say, WinZip®. More generally, this variant of the invention encourages habits which are desirable, but which as yet lack support from credible systems: if the source is digital, keep it digital, online and on paper.

### BRIEF SUMMARY OF THE INVENTION

A basic embodiment of the invention is a computer program that facilitates and standardizes the exchange of digital information among people, by way of computers and business cards. The program creates a computer representation that serves to transfer digitized information to a business card. The program also reads information from business cards that have been digitally encoded. In addition, the program automates the extraction of information from databases of PIM's, or similar software, particularly, but not exclusively, for the purpose of creating digital business cards. The program also automates the transfer of information to PIM databases, particularly, but not exclusively, when such information is read from digital business cards. The invention may also manifest as distinct programs whose respective purposes are to create and read digital business cards, and the digital encoding need not be restricted to contact information.

Similarly, the invention may also manifest as a program or programs for creating and reading digital forms, letters, and other documents.

### BRIEF DESCRIPTION OF THE DRAWINGS

FIG. 1 depicts the process workflow enabled by the invention, in its basic embodiment.

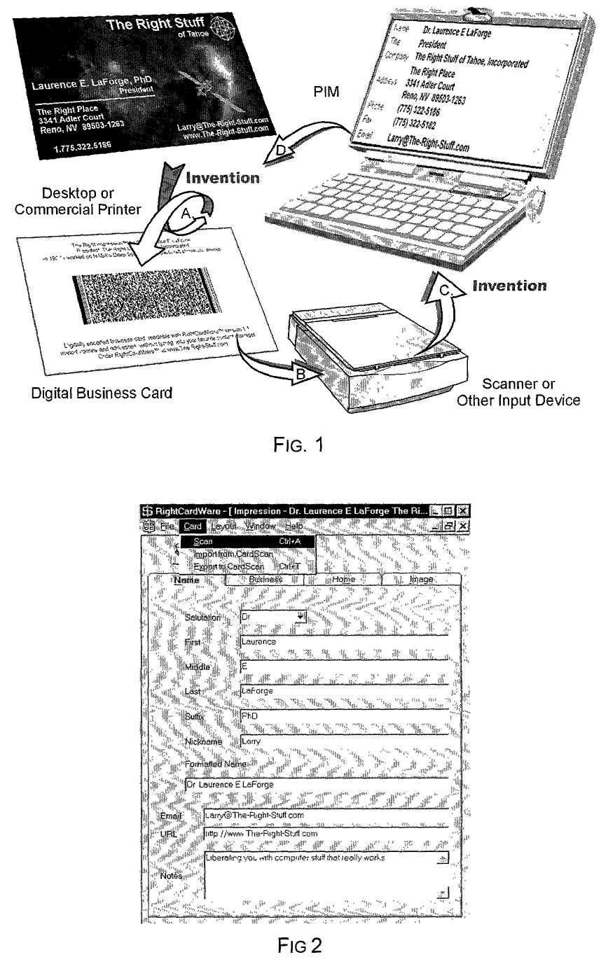

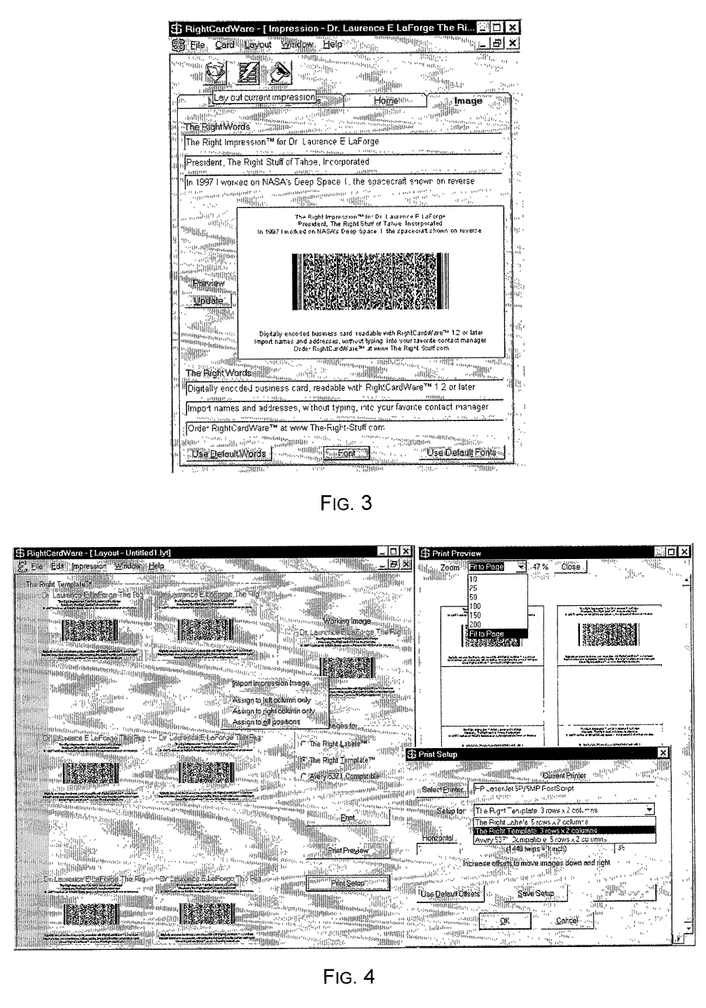

A. In this illustration of BACKGROUND section item (a), the user employs the invention's GUI to capture contact information, via the online file mentioned under item (f). Here also illustrating BACKGROUND item (b), the invention digitizes the contact information of FIG. 1A as a bitmap image of a bar code—in this case PDF417—that facilitates printing via commercial or desktop presses. The user prints the image to the back side of business cards.

B. The user employs a standard scanner, such as the flatbed model depicted here, to input the image created in FIG. 1A. In this illustration of BACKGROUND item (c), the invention automates such input by setting up and commanding the scanner.

C. Here illustrating BACKGROUND items (d) and (e), the invention extracts contact information from the scanned image, and transfers the information to a PIM of the user's choice.

D. The invention facilitates multi-platform, multi-modal capture and editing of contact information, not only via GUI entry of FIG. 1A, but by automating the input of an entire record of contact information from a PIM.

FIG. 2 depicts a screen shot of the GIU for a possible implementation of the invention, in its basic embodiment. See also the description for FIG. 1A.

FIG. 3 elaborates FIG. 1A, wherein the invention creates, and enables modification of, a master image of digitally encoded contact information—in this case a PDF417 bar code—as well as additional, human-readable text featuring a description of what the image is, and how it can be used.

FIG. 4 further elucidates FIG. 1A, whence the invention prepares, formats, and, via operating system printer driver, transfers copies of the master image of FIG. 3 to the business card itself.

### DETAILED DESCRIPTION OF THE INVENTION

In its basic embodiment, the invention manifests as a computer program, preferably, but not necessarily, one with a GUI (FIG. 1A, FIGS. 2, 3, and 4). Referring to FIG. 1, the program facilitates and standardizes exchange of digital information among people, by way of computers and business cards. Referring to FIGS. 3 and 4, the program creates a computer representation that serves to transfer digitized information to a business card. Referring to FIG. 1C, the program also reads information from business cards that have been digitally encoded. In addition, and referring to FIG. 1D, the program automates the extraction of information from databases of PIM's, or similar software, particularly, but not exclusively, for the purpose of creating digital business cards. The program also automates the transfer of information to PIM databases, particularly, but not exclusively, when such information is read from digital business cards.

The invention may manifest in a version that only creates digital business cards (FIG. 1A), in a version that only reads digital business cards (FIGS. 1B, C), or in a version that performs both such functions (FIGS. 1A, B, C). The digital encoding need not be restricted to contact information. In the remainder of this section, a preponderance of examples pertain to the case where the program can both create and read digital business cards.

The program may run on any of several computing platforms. In some manifestations, the program may run on a personal computer; in others, it may run on a website or network server, or in combination with a web browser. The program may also run on a personal digital assistant (PDA) or other device for portable computing.

An important, novel aspect of the program is a format which associates the meaning of PIM data with the data itself, and which may be efficaciously and securely encrypted. The program creates this format from a PIM database, and expresses this format in a fashion that enables output devices, indirectly or under the program's direct control, to physically transfer this data to the business card (FIGS. 1A, 3, 4). To read a digital business card, and at the initiation of the user, the program commands an input device, directly or indirectly, to extract physical data from the business card (FIG. 1B), to transfer a representation of that data to computer memory under the program's control (FIG. 1C), and to convert that representation to the program's format (FIG. 1C). The program embodies knowledge of PIM's and PIM databases in order to transfer information to and from PIM's or similar software (FIG. 1C).

The program applies particularly, but not exclusively, to the creating and reading of business cards whose digital content manifests as a bar code. Consistent with items (g) and (h), as described in the invention BACKGROUND, output devices for creating a digital business card would include ink-based printing devices, whether of the less expensive desktop variety, or the more expensive presses used by commercial print shops (FIG. 1A). Consistent with the invention's objectives for multi-platform interoperability, input devices for reading digital business cards include items (i) through (k) described in the invention BACKGROUND.

Beneficial applications of the invention include, but are not restricted to, scenarios such as the following.

Reading. (FIGS. 1B, C). The user attends a convention, professional meeting, or sales gathering. The user returns to his or her office with a large number of business cards, a preponderance of which have been digitally encoded using the program. The user inputs the cards into a scanning device, which may feature automatic detect and feeding. The program automatically reads the cards into the user's PIM database, without error, and without the need for corrective intervention on the part of the user. The user can then contact people added to his or her PIM by any of several features prevalent in PIM software.

Recalling the fourth paragraph of invention Background, such PIM features include automatic phone dialing, automatic retrieval of email addresses, automatic composition of mailing lists, and automatic printing of mailing labels. The user can be confident that the digitally encoded information on the business cards was accurately transferred. Hence, the user is relieved from the burden of correcting the scanned information, or of storing the cards or card images.

Creating. (FIGS. 1A, D). The user invokes the program for the purpose of creating a bar code to be printed on the back of his or her business card. Refer to FIG. 2. The user keys in his or her own contact information; e.g. name, telephone numbers, address, email handle, and Uniform Resource Locator (URL). Alternatively, and more conveniently, the user may command the program to import his or her contact information from a PIM database.

As an important variation on this scenario, the user may be a commercial typesetter, or a professional employed by a commercial typesetter. In this case the user invokes the program to create a digital business card commissioned by a customer.

In addition to contact or PIM database information, the program allows the user to embed any digital object that is standard to computers. Such objects include, but are not limited to, photographs, audio and video tracks, and other programs. The number and size of such objects are governed by the digital capacity of the business card. This, in turn, is determined by the storage mechanism and capacity made available on the business card, and by the program's method of utilizing this storage.

At the behest of the user, the program creates a master copy of the digitally encoded business card, and displays a representation of this master copy. The program facilitates modification of this master copy, including, but not limited to, annotations about the information or objects to be encoded on the business card. FIG. 3 illustrates this behavior where the digitized information manifests as a bar code.

At the behest of the user, the program prepares and arranges one or more copies of master digital images for output to a physical medium. This includes business cards imprinted with a bar code, but may also include: holographic business cards, business cards which embed smart chips or integrated circuits, business cards with magnetic stripes, and business cards embodied as compact disks, perhaps rectangularly shaped. With respect to bar codes, in particular, the program prepares and formats copies of the master, or masters, for transfer via standard or novel paper-based printing methods (FIG. 4).

The latter include, but are not limited to, commercial printing presses or printers attached to computers or computer networks. With respect to the latter, in particular, the program enables the printing of copies of a master, or masters, to a sheet of self-stick labels, to a perforated sheet of business card blanks, or directly to the blank side of already printed business cards, inserted for that purpose into an aligning template.

The program can read and extract any information or object that it digitizes onto a business card. In a pervasive variant of the basic embodiment, the program runs compatibly on a number of computing platforms, transfers information to and from a board spectrum of PIMs, and makes use of a wide variety of input and output devices and peripherals. The latter include, but are not restricted to, combinations of optical scanners, as well as paper-based printers. Unlike Smith '052, whose claims are restricted to pen or capped-pen reading devices, the present invention achieves flexible interaction over a broad spectrum of input devices. In a preferred embodiment as software, that is, the invention is largely independent of the packaging characteristics of the scanners, or other input devices, that it commands. By contrast with Desai '105, moreover, the present invention does not incorporate a PIM as part of a self-contained package. Indeed, duplicating the functionality of existing PIM's would, arguably, dilute the attractiveness of the present invention. On the other hand, the present invention creates digital business cards, while Desai '105 does not. In breadth and in depth, the present invention embodies a novel and useful process for facilitating and standardizing the exchange of digital information among people, by way of computers and business cards.

The invention having been described in preferred embodiments for creating and reading digital business cards, it should be apparent, especially in light of the foundation laid in the invention BACKGROUND, how to achieve analogous behavior for the case of digital forms and stationery.

It is understood that the invention is capable of further modification, uses and/or adaptations following in general the principle of the invention and including such departures from the present disclosure as come within known or customary practice in the art to which the invention pertains, and as may be applied to the essential features set forth, and fall within the scope of the invention, with specific claims enumerated as follows.

We claim:

1. A system for creating digital business cards, comprising means for capturing contact information, or information pertinent to computer applications which process such information; and digitizing said information into a master image, copies of which are suitable for printing onto paper stock.

2. A system for reading digital business cards, comprising means for scanning an image of digitized contact information, or information pertinent to computer applications which process such information; and converting and transferring that information into a PIM, or into computer applications which process such information.

3. The system recited in claim 1, with digital forms or stationery in addition to business cards.

4. The system recited in claim 2, with digital forms or stationery in addition to business cards.

5. A substantially interchangeable representation of the information and image recited in claim 3.

6. The system recited in claim 3, where the image is that of a bar code.

7. The system recited in claim 4, where the image is that of a bar code.

8. The representation recited in claim 5, where the image is that of a bar code.

9. The system recited in claim 3, with a master format in addition to a master image; and with the additional provision that copies of the master format be suitable for rendering onto magnetic or optical media, holographic media, or smart chips.

10. The system recited in claim 4, with the provision that, in addition to scanning an image, the system may read from magnetic or optical media, holographic media, or smart chips.

11. The representation recited in claim 5, where, in addition, the interchange subsumes magnetic or optical media, holographic media, or smart chips.

12. The system recited in claim 9, where the image is that of a bar code.

13. The system recited in claim 10, where the image is that of a bar code.

14. The representation recited in claim 11, where the image is that of a bar code.
